(19) United States
(12) Patent Application Publication
(10) Pub. No.: US 2026/0185813 A1
(43) Pub. Date: Jul. 2, 2026

(54) PHASE GENERATED CARRIER INTERROGATOR AND ASSOCIATED PHASE GENERATED CARRIER INTERROGATION METHOD

(71) Applicant: ASML Netherlands B.V., Veldhoven (NL)

(72) Inventor: Teunis Jan IKKINK, Geldrop (NL)

(73) Assignee: ASML Netherlands B.V., Veldhoven (NL)

(21) Appl. No.: 19/130,995

(22) PCT Filed: Nov. 9, 2023
(86) PCT No.: PCT/EP2023/081311

§ 371 Date: May 19, 2025

(30) Foreign Application Priority Data
Dec. 6, 2022 (EP) 22211743.4
Dec. 15, 2022 (EP) 22213974.3

(51) Int. Cl. G01B 9/02004; G01B 9/02

(52) U.S. Cl. CPC G01B 9/02004; G01B 9/02083

(57) ABSTRACT

Disclosed is a phase generated carrier interrogator comprising: one or more interferometers, each interferometer operable to receive modulated radiation and to generate a respective interferometer signal comprising a phase of interest induced by a measurand, each said interferometer signal also comprising a periodic phase modulation induced by said modulated radiation, wherein the periodic phase modulation comprises an amplitude described by a respective modulation index for each interferometer; at least one detector operable to detect each interferometer signal; and a signal processing module. The signal processing module is operable to: estimate the modulation index respectively for each interferometer, obtain a respective estimated modulation index for each interferometer; demodulate each interferometer signal using its respective estimated modulation index to estimate a respective phase of interest from each interferometer signal thereby obtaining a respective estimated phase of interest value for each interferometer.

### CROSS-REFERENCE TO RELATED APPLICATION

The application claims priority of EP Application Serial No. 22211743.4 filed on 6 Dec. 2022 and EP Application Serial No. 22213974.3 filed on 15 Dec. 2022, and which are incorporated herein in their entirety by reference.

### FIELD

The present invention relates to interferometry, and in particular to methods and apparatuses for phase generated carrier (PGC) interferometer interrogation. The present invention also relates to a lithographic apparatus and a projection system for optical lithography systems comprising a position measuring system.

### BACKGROUND

A lithographic apparatus is a machine constructed to apply a desired pattern onto a substrate. A lithographic apparatus can be used, for example, in the manufacture of integrated circuits (ICs). A lithographic apparatus may, for example, project a pattern (also often referred to as “design layout” or “design”) of a patterning device (e.g., a mask) onto a layer of radiation-sensitive material (resist) provided on a substrate (e.g., a wafer).

As semiconductor manufacturing processes continue to advance, the dimensions of circuit elements have continually been reduced while the amount of functional elements, such as transistors, per device has been steadily increasing over decades, following a trend commonly referred to as ‘Moore's law’. To keep up with Moore's law the semiconductor industry is chasing technologies that enable to create increasingly smaller features. To project a pattern on a substrate a lithographic apparatus may use electromagnetic radiation. The wavelength of this radiation determines the minimum size of features which are patterned on the substrate. Typical wavelengths currently in use are 365 nm (i-line), 248 nm, 193 nm and 13.5 nm. A lithographic apparatus, which uses extreme ultraviolet (EUV) radiation, having a wavelength within a range of 4 nm to 20 nm, for example 6.7 nm or 13.5 nm, may be used to form smaller features on a substrate than a lithographic apparatus which uses, for example, radiation with a wavelength of 193 nm.

Within a lithographic apparatus, it is important to accurately measure the position of certain components of the lithographic apparatus. Such components may comprise inter alia one or more wafer (or substrate) stages, the reticle (or mask) stage and/or one or more optical components (e.g., mirrors within a projection system of the lithographic apparatus. To do this, an interferometer may be used, and in particular a multi-axis interferometer. A multi-axis interferometer may comprise multiple individual interferometers, one per axis, wherein each axis relates to position measurement of a different degree of freedom. In an embodiment, the interferometer may comprise a 6-axis interferometer for position measurement in 6 degrees of freedom: three mutually perpendicular spatial axes, conventionally referred to as the x-axis, y-axis and z axis, and rotations around each of these axes Rx, Ry, Rz.

It would be desirable to improve on such interferometers, and in particular to multi-axis interferometers.

### SUMMARY

In a first aspect of the invention, there is provided a phase generated carrier interrogator, comprising: one or more interferometers, each said one or more interferometers being operable to receive modulated radiation and to generate a respective interferometer signal comprising a phase of interest induced by a measurand, each said interferometer signal also comprising a periodic phase modulation induced by said modulated radiation, wherein the periodic phase modulation comprises an amplitude described by a respective modulation index for each said one or more interferometers; at least one detector operable to detect each said interferometer signal; and a signal processing module operable to: estimate the modulation index respectively for each said one or more interferometers to obtain a respective estimated modulation index for each said one or more interferometers; and demodulate each of said interferometer signals using its respective estimated modulation index to estimate a respective phase of interest from each of said interferometer signals thereby obtaining a respective estimated phase of interest value for each said interferometer.

In a second aspect of the invention, there is provided a method of processing one or more interferometer signals to determine an estimated phase of interest value induced by a measurand, each of the one or more interferometer signals being obtained from a respective interferometer of one or more interferometers; the method comprising: modulating radiation for each said one or more interferometers to apply a periodic phase modulation having an amplitude described by a respective modulation index for each interferometer; detecting a respective interferometer signal for each said one or more interferometers, each interferometer signal comprising a phase of interest induced by the measurand in addition to said periodic phase modulation; estimating the modulation index respectively for each said one or more interferometers to obtain a respective estimated modulation index for each said one or more interferometers; and demodulating each of said interferometer signals using its respective estimated modulation index to estimate a respective phase of interest from each of said interferometer signals thereby obtaining a respective estimated phase of interest value for each said interferometer.

### BRIEF DESCRIPTION OF THE DRAWINGS

Embodiments of the invention will now be described, by way of example only, with reference to the accompanying schematic drawings, in which:

FIG. 1 depicts a schematic overview of a lithographic apparatus;

FIG. 2 is a flow diagram conceptually illustrating a signal processing method in PGC interferometry according to a known method;

FIG. 3 is a flow diagram conceptually illustrating a signal processing method in PGC interferometry according to a an embodiment, at a first level of abstraction;

FIG. 4 is a flow diagram conceptually illustrating the signal processing method illustrated in FIG. 3, at a second, lower, level of abstraction; and

FIG. 5 is a flow diagram conceptually illustrating the signal processing method illustrated in FIG. 3, at a third, lowest, level of abstraction.

### DETAILED DESCRIPTION

In the present document, the terms “radiation” and “beam” are used to encompass all types of electromagnetic radiation, including ultraviolet radiation (e.g. with a wavelength of 365, 248, 193, 157 or 126 nm) and EUV (extreme ultra-violet radiation, e.g. having a wavelength in the range of about 5-100 nm). Interferometers described herein may use radiation having a wavelength greater than 400 or greater than 500 nm. More specifically, by way of specific examples, the interferometer radiation wavelength may be 633 nm or 1530 nm.

The term “reticle”, “mask” or “patterning device” as employed in this text may be broadly interpreted as referring to a generic patterning device that can be used to endow an incoming radiation beam with a patterned cross-section, corresponding to a pattern that is to be created in a target portion of the substrate. The term “light valve” can also be used in this context. Besides the classic mask (transmissive or reflective, binary, phase-shifting, hybrid, etc.), examples of other such patterning devices include a programmable mirror array and a programmable LCD array.

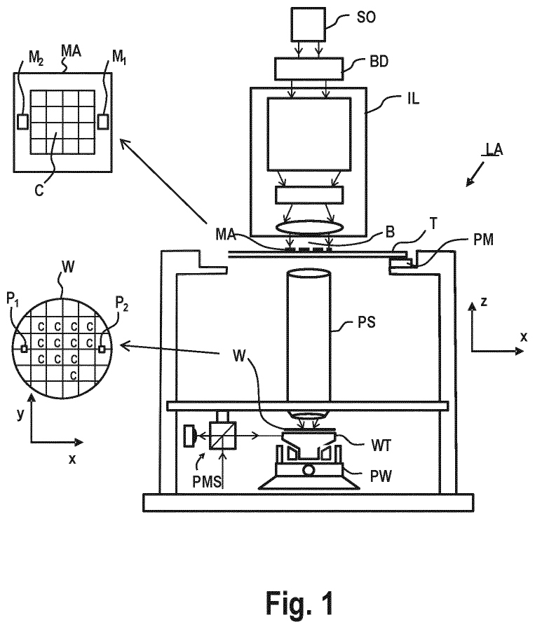

FIG. 1 schematically depicts a lithographic apparatus LA. The lithographic apparatus LA includes an illumination system (also referred to as illuminator) IL configured to condition a radiation beam B (e.g., UV radiation, DUV radiation or EUV radiation), a mask support (e.g., a mask table) MT constructed to support a patterning device (e.g., a mask) MA and connected to a first positioner PM configured to accurately position the patterning device MA in accordance with certain parameters, a substrate support (e.g., a wafer table) WT constructed to hold a substrate (e.g., a resist coated wafer) W and connected to a second positioner PW configured to accurately position the substrate support in accordance with certain parameters, and a projection system (e.g., a refractive projection lens system) PS configured to project a pattern imparted to the radiation beam B by patterning device MA onto a target portion C (e.g., comprising one or more dies) of the substrate W.

In operation, the illumination system IL receives a radiation beam from a radiation source SO, e.g. via a beam delivery system BD. The illumination system IL may include various types of optical components, such as refractive, reflective, magnetic, electromagnetic, electrostatic, and/or other types of optical components, or any combination thereof, for directing, shaping, and/or controlling radiation. The illuminator IL may be used to condition the radiation beam B to have a desired spatial and angular intensity distribution in its cross section at a plane of the patterning device MA.

The term “projection system” PS used herein should be broadly interpreted as encompassing various types of projection system, including refractive, reflective, catadioptric, anamorphic, magnetic, electromagnetic and/or electrostatic optical systems, or any combination thereof, as appropriate for the exposure radiation being used, and/or for other factors such as the use of an immersion liquid or the use of a vacuum. Any use of the term “projection lens” herein may be considered as synonymous with the more general term “projection system” PS.

The lithographic apparatus LA may be of a type wherein at least a portion of the substrate may be covered by a liquid having a relatively high refractive index, e.g., water, so as to fill a space between the projection system PS and the substrate W-which is also referred to as immersion lithography. More information on immersion techniques is given in U.S. Pat. No. 6,952,253, which is incorporated herein by reference.

The lithographic apparatus LA may also be of a type having two or more substrate supports WT (also named “dual stage”). In such “multiple stage” machine, the substrate supports WT may be used in parallel, and/or steps in preparation of a subsequent exposure of the substrate W may be carried out on the substrate W located on one of the substrate support WT while another substrate W on the other substrate support WT is being used for exposing a pattern on the other substrate W.

In addition to the substrate support WT, the lithographic apparatus LA may comprise a measurement stage. The measurement stage is arranged to hold a sensor and/or a cleaning device. The sensor may be arranged to measure a property of the projection system PS or a property of the radiation beam B. The measurement stage may hold multiple sensors. The cleaning device may be arranged to clean part of the lithographic apparatus, for example a part of the projection system PS or a part of a system that provides the immersion liquid. The measurement stage may move beneath the projection system PS when the substrate support WT is away from the projection system PS.

In operation, the radiation beam B is incident on the patterning device, e.g. mask, MA which is held on the mask support MT, and is patterned by the pattern (design layout) present on patterning device MA. Having traversed the mask MA, the radiation beam B passes through the projection system PS, which focuses the beam onto a target portion C of the substrate W. With the aid of the second positioner PW and a position measurement system IF, the substrate support WT can be moved accurately, e.g., so as to position different target portions C in the path of the radiation beam B at a focused and aligned position. Similarly, the first positioner PM and possibly another position sensor (which is not explicitly depicted in FIG. 1) may be used to accurately position the patterning device MA with respect to the path of the radiation beam B. Patterning device MA and substrate W may be aligned using mask alignment marks M1, M2 and substrate alignment marks P1, P2. Although the substrate alignment marks P1, P2 as illustrated occupy dedicated target portions, they may be located in spaces between target portions. Substrate alignment marks P1, P2 are known as scribe-lane alignment marks when these are located between the target portions C.

To clarify the invention, a Cartesian coordinate system is used. The Cartesian coordinate system has three axes, i.e., an x-axis, a y-axis and a z-axis. Each of the three axes is orthogonal to the other two axes. A rotation around the x-axis is referred to as an Rx-rotation. A rotation around the y-axis is referred to as an Ry-rotation. A rotation around about the z-axis is referred to as an Rz-rotation. The x-axis and the y-axis define a horizontal plane, whereas the z-axis is in a vertical direction. The Cartesian coordinate system is not limiting the invention and is used for clarification only. Instead, another coordinate system, such as a cylindrical coordinate system, may be used to clarify the invention. The orientation of the Cartesian coordinate system may be different, for example, such that the z-axis has a component along the horizontal plane.

The position measurement system PMS may comprise any type of sensor that is suitable to determine a position of the substrate support WT. The position measurement system PMS may comprise any type of sensor that is suitable to determine a position of the mask support MT. The sensor may be an optical sensor such as an interferometer or an encoder. The position measurement system PMS may comprise a combined system of an interferometer and an encoder. The sensor may be another type of sensor, such as a magnetic sensor, a capacitive sensor or an inductive sensor. The position measurement system PMS may determine the position relative to a reference, for example the metrology frame MF or the projection system PS. The position measurement system PMS May determine the position of the substrate table WT and/or the mask support MT by measuring the position or by measuring a time derivative of the position, such as velocity or acceleration.

The position measurement system PMS may comprise an encoder system. An encoder system is known from for example, United States patent application US2007/0058173A1, filed on Sep. 7, 2006, hereby incorporated by reference. The encoder system comprises an encoder head, a grating and a sensor. The encoder system may receive a primary radiation beam and a secondary radiation beam. Both the primary radiation beam as well as the secondary radiation beam originate from the same radiation beam, i.e., the original radiation beam. At least one of the primary radiation beam and the secondary radiation beam is created by diffracting the original radiation beam with the grating. If both the primary radiation beam and the secondary radiation beam are created by diffracting the original radiation beam with the grating, the primary radiation beam needs to have a different diffraction order than the secondary radiation beam. Different diffraction orders are, for example, +1^{st} order, −1^{st} order, +2^{nd} order and −2^{nd} order. The encoder system optically combines the primary radiation beam and the secondary radiation beam into a combined radiation beam. A sensor in the encoder head determines a phase or phase difference of the combined radiation beam. The sensor generates a signal based on the phase or phase difference. The signal is representative of a position of the encoder head relative to the grating. One of the encoder head and the grating may be arranged on the substrate structure WT. The other of the encoder head and the grating may be arranged on the metrology frame MF or the base frame BF. For example, a plurality of encoder heads are arranged on the metrology frame MF, whereas a grating is arranged on a top surface of the substrate support WT. In another example, a grating is arranged on a bottom surface of the substrate support WT, and an encoder head is arranged below the substrate support WT.

The position measurement system PMS may comprise an interferometer system. An interferometer system is known from, for example, United States patent U.S. Pat. No. 6,020,964, filed on Jul. 13, 1998, hereby incorporated by reference. The interferometer system may comprise a beam splitter, a mirror, a reference mirror and a sensor. A beam of radiation is split by the beam splitter into a reference beam and a measurement beam. The measurement beam propagates to the mirror and is reflected by the mirror back to the beam splitter. The reference beam propagates to the reference mirror and is reflected by the reference mirror back to the beam splitter. At the beam splitter, the measurement beam and the reference beam are combined into a combined radiation beam. The combined radiation beam is incident on the sensor. The sensor determines a phase or a frequency of the combined radiation beam. The sensor generates a signal based on the phase or the frequency. The signal is representative of a displacement of the mirror. In an embodiment, the mirror is connected to the substrate support WT. The reference mirror may be connected to the metrology frame MF. In an embodiment, the measurement beam and the reference beam are combined into a combined radiation beam by an additional optical component instead of the beam splitter.

It is proposed that interferometry for the position measurement system may use phase generated carrier (PGC) interferometer interrogation. PGC interferometry requires less expensive interferometer hardware than conventional homodyne or heterodyne interrogation techniques, but requires more complicated signal processing.

A radiation source or laser source such as a wavelength-modulated laser diode may be used in combination with an unbalanced interferometer (having a nonzero optical path difference OPD), to create a periodic phase modulation or sinusoidal modulation m·sin (ω_{mod}·t) of the interferometer phase, in addition to the phase of interest φ(t) induced by the measurand. The modulation index m of this modulation can be described by

$$m = 2 π \cdot \frac{OPD}{c} \cdot {\hat{v}}_{exc} ,$$

\hat{v}_{exc} is the laser frequency excursion amplitude and c is the speed of light.

The wavelength modulation may be created in a number of different ways, of which two alternative methods will be described: 1) the emission wavelength of the laser may be changed (this is the lowest cost option) or 2) the laser may be operated at constant emission frequency and the periodic wavelength modulation created by an additional (electro-optic) phase modulator component downstream from the laser but common to all interferometers. This latter method has an advantage over the first method in that it avoids modulation of the laser output power, which is a source of inaccuracy.

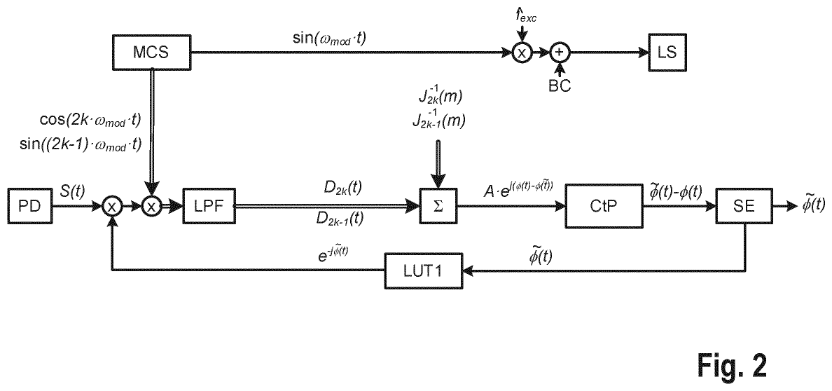

FIG. 2 is a flow diagram conceptually illustrating the signal processing in PGC interferometry. A multi-carrier synthesizer generates the sinusoidal modulation sin (ω_{mod}·t) for a laser diode LD of the interferometer. This sinusoidal modulation is combined with (e.g., multiplied by) the modulation amplitude or current excitation amplitude Î_{exc} and further combined with (e.g., summed with) the bias current BC. This laser current excitation amplitude Î_{exc} is related to the laser frequency excursion amplitude \hat{v}_{exc} by:

$${\hat{v}}_{exc} = η \cdot {\hat{ι}}_{exc}$$

where η is the laser's current to frequency sensitivity.

The optical power (interferometer signal) detected by the photodetector PD of the interferometer can then be written as:

$$S ( t ) = B + A \cdot cos ( m \cdot sin ( {ω}_{mod} \cdot t ) + ϕ ( t ) )$$

where B is a background power and A is the amplitude of the power of the interference fringes. The ratio A/B is the interference contrast and satisfies 0≤A/B≤1. The phase modulation amplitude m will be referred to as the modulation index from hereon.

This sinusoidal phase modulation serves to generate a series of demodulation carrier frequencies or phase-generated carrier frequencies in the detected output power of the interferometer as harmonics of the modulation frequency. These phase-generated carriers may take the form of:

$$sin ( ( 2 k - 1 ) \cdot {ω}_{mod} \cdot t ) ,$$

$$cos ( 2 k \cdot {ω}_{mod} \cdot t )$$

where k represents integers between 1 and infinity to define orders n.

The amplitudes of odd-order carrier frequencies (carriers) are proportional to the sine of the measurand-induced phase φ(t), and the amplitudes of even-order carrier frequencies (carriers) are proportional to the cosine of the measurand-induced phase φ(t). Each carrier of order n is also attenuated by the modulation index dependent factor Jₙ(m), which is a Bessel function of the first kind of order n (where), J₀(m) is a DC component of the Fourier series described by the bracketed terms). Therefore the optical power S(t) may be described as:

$$S ( t ) = B + A \cdot cos ϕ ( t ) \cdot ( {J}_{0} ( m ) + 2 {\sum }_{k = 1}^{∞} {J}_{2 k} ( m ) \cdot cos ( 2 k \cdot {ω}_{mod} \cdot t ) ) - A \cdot sin ϕ ( t ) \cdot ( 2 {\sum }_{k = 1}^{∞} {J}_{2 k - 1} ( m ) \cdot sin ( ( 2 k - 1 ) \cdot {ω}_{mod} \cdot t ) ) .$$

The time-varying measurand-induced phase φ(t) (and its temporal derivate(s)) is not directly accessible. Instead, this measurand-induced phase φ(t) (the phase of interest) may be estimated by a dynamic state estimator SE, also known as the process model (e.g., which models the dynamic state of the measurand; for example this may be the instantaneous position of a body such as a stage). This estimation process may calculate a phase prediction φ̅(t) (estimated phase of interest value), which can be compared to the true measurand-induced phase φ(t) comprised in the signal S(t). The phase residual φ̅(t)-φ(t) from this comparison can be used to correct the dynamic state predicted by the process model SE. As such, the dynamic state estimator may determine a new state comprising said estimated phase prediction φ̅ (t from a previous state and from said phase residual φ̅(t)-φ(t) The corrected state is the output of the system. The resulting estimation loop is actually a (digital) phase-locked loop (PLL), which in turn is a Kalman filter.

By proper processing of the signal S(t) (e.g., within a signal processing module), a complex phasor A·e^{j(φ(t)-φ̅(t))} (first phasor) can be constructed which has the desired phase residual φ̅(t)-φ(t) as its argument. The required signal processing involves three conceptual steps. In a first step, the interferometer signal S(t) is multiplied by a unity-magnitude complex conjugate phasor e^{-jφ̅(t)} having an argument which is the negative phase prediction −φ̅(t). A first look-up table or sine/cosine look-up table LUT1 can be used to construct this phasor. In a second step, respective demodulate components Dₙ(t) or demodulates are formed respectively for each carrier to be taken into account (i.e., at least one of even-order and one of odd-order). Synchronous demodulation involves multiplication by the respective carrier cos (2k·ω_{mod}·t), −sin ((2k−1)·ω_{mod}·t), followed by low-pass filtering LPF. These two steps together result in the following even-order and odd-order demodulates:

$${D}_{2 k} = 〈 S ( t ) \cdot {e}^{- j \hat{ϕ} ( t )} \cdot cos ( 2 k \cdot {ω}_{mod} \cdot t ) 〉 \approx A \cdot \frac{1}{2} 〈 {e}^{j ( ϕ ( t ) - \hat{ϕ} ( t ) )} + {e}^{- j ( ϕ ( t ) - \hat{ϕ} ( t ) )} 〉 \cdot {J}_{2 k} ( m )$$

$${D}_{2 k - 1} = - 〈 S ( t ) \cdot {e}^{- j \hat{ϕ} ( t )} \cdot sin ( ( 2 k - 1 ) \cdot {ω}_{mod} \cdot t ) 〉 \approx - j \cdot A \cdot \frac{1}{2} 〈 {e}^{j ( ϕ ( t ) - \hat{ϕ} ( t ) )} - {e}^{- j ( ϕ ( t ) + \hat{ϕ} ( t ) )} 〉 \cdot {J}_{2 k - 1} ( m )$$

where the chevrons [symbol] [symbol] denote the time-averaging or low-pass filtering. Each demodulate comprises two low-pass filtered phasors: a first phasor comprising the desired argument φ̅(t)-φ(t) and an additional phasor having the argument −(φ̅(t)+φ(t)). In the situation where the process model is tracking the desired phase φ̅(t) closely, the phase residual φ̅(t)-φ(t) will be small and the corresponding first phasor A·e^{j(φ(t)+φ̅(t))} will continuously be near or at the real axis. However, the additional phasor A·e^{-j (φ(t)+φ̅(t))} will revolve at a rate of twice the rate of change of the measurand-induced phase φ(t), which can be substantial. Thus, depending on the rate of change (e.g., velocity) this additional phasor will experience attenuation by the lowpass filtering action, while the desired first phasor will not.

In the third processing step, even-order and odd-order demodulates are combined, by a properly weighted summation, in order to remove the additional phasor. In the simplest case, where one even-order demodulate is combined with one odd-order demodulate, the proper weighting coefficients are the reciprocal Bessel functions:

$${J}_{2 k}^{- 1} ( m ) \cdot {D}_{2 k} + j \cdot {J}_{2 k - 1}^{- 1} ( m ) \cdot {D}_{2 k - 1} \approx A \cdot {e}^{j ( ϕ - \hat{ϕ} )} .$$

Note that the digital low-pass filters LPF acting on both of these demodulates are identical and therefore the second phasors of each of these demodulates will cancel each other.

The above three processing steps result in a phase-residual first phasor A·e^{j(φ(t)-φ̅(t))} that, provided that the estimate φ̅(t) is accurate such that the phase residual φ̅(t)-φ(t) approaches zero, is on or near the real axis. Magnitude and phase residual can now be separated by inputting this phasor into a Cartesian-to-Polar coordinate transformation unit CtP, which may be conveniently implemented in a FPGA (or in software) as a CORDIC algorithm, for example. For notational convenience the time-dependence of the phase residual φ̅(t)-φ(t) will now be dropped, since it is quasi-static.

It can be appreciated from the above description that the Bessel functions applied in the third processing step described above are dependent on the modulation index m. As has already been described, modulation index m is determined by the product of the optical frequency (or wavelength) excursion amplitude \hat{v}_{exc} and the optical path difference OPD; i.e., according to:

$$m = 2 π \cdot {\hat{v}}_{exc} \cdot \frac{OPD}{c}$$

where c is the speed of light.

Most PGC interrogators employ an approach in which the modulation index m is controlled towards some convenient operating point, by adjusting the optical frequency excursion amplitude \hat{v}_{exc} (e.g., by means of the laser current amplitude î_{exc}). A convenient operating point may be, for example, one at which the Bessel function corresponding to a particular carrier becomes zero, while the amplitude of an odd/even pair of other carriers achieves near-maximum strength. At such a predetermined operating point the ratio of the amplitudes of the members of the odd/even pair are known a priori (being the ratio of the corresponding Bessel functions). This a priori knowledge can be used to equalize these amplitudes and construct a phasor of constant magnitude A.

Such an approach works well for a single interferometer and laser arrangement, or where each interferometer of an interrogator has a respective dedicated laser for which its modulation index can be individually controlled, e.g., by adjusting the optical frequency excursion amplitude individually for each laser and therefore for each interferometer. However, this may be impractical in terms of cost and/or volume for a multi-axis interrogator such as might be used, for example, as part of a position measurement system within a lithographic apparatus. As each axis essentially comprises a respective different interferometer, to implement such an approach may require a laser per axis; e.g., such that six lasers are required, one for each of six axes for a 6 degree of freedom position measurement system.

To reduce cost and/or volume, it may be desirable to use a single laser for each interferometer (or at least fewer lasers than interferometers), therefore enabling an implementation of a multi-axis interferometry device (e.g., a multi-axis PGC interferometer interrogator) using only a single laser. Present methods of controlling the modulation index to enable the aforementioned signal processing are no longer possible when one laser is used for multiple interferometers. This is because the OPDs of each interferometer will, in general, be different, and therefore the corresponding modulation indices will also be different for a single optical frequency excursion amplitude setting (laser current amplitude setting). This makes it impossible to construct a constant-magnitude phasor for all axes simultaneously. This will translate into cyclic errors, i.e., measurement accuracy degradation, for small deviations of the modulation index. Singularities, loss of lock, and/or sign reversal of the measurand motion may occur for larger deviations.

A method is disclosed herein wherein the demodulation of the measured signal is performed using an estimated demodulation index value based on the relative amplitudes of N≥2 even-order carrier frequencies and the relative amplitudes of N≥2 odd-order carrier frequencies. While the method can be used for a single interferometer as an alternative to present methods of controlling the modulation index at a set value, a main application will be to facilitate using a single laser for multiple interferometers (e.g., as part of a multi-axis interrogator). Such a method will make it possible to construct a constant-magnitude phasor for multiple interferometers, and therefore multiple measurement axes, simultaneously when only a single laser source is used for the multiple interferometers.

The basic concept comprises, rather than controlling the modulation index to a predetermined value, allowing each measurement axis to have a respective modulation index which is allowed to vary individually over time as the OPD of its axis varies (due to changing measurand). Each of these modulation indices are then estimated, with the estimated value for each axis used to demodulate a respective measured signal from that axis.

As such, disclosed is a phase generated carrier interrogator and associated signal processing method, the phase generated carrier interrogator comprising: one or more interferometers, each said one or more interferometers being operable to receive (e.g., frequency) modulated radiation and to generate a respective interferometer signal comprising a phase of interest induced by a measurand, each said interferometer signal also comprising a periodic phase modulation induced by said modulated radiation, wherein the periodic phase modulation comprises an amplitude described by a respective modulation index for each said one or more interferometers; at least one detector operable to detect each said interferometer signal; and a signal processing module operable to: estimate the modulation index respectively for each said one or more interferometers to obtain a respective estimated modulation index for each said one or more interferometers; and demodulate each of said interferometer signals using its respective estimated modulation index to estimate a respective phase of interest from each of said interferometer signals thereby obtaining a respective estimated phase of interest value for each said interferometer.

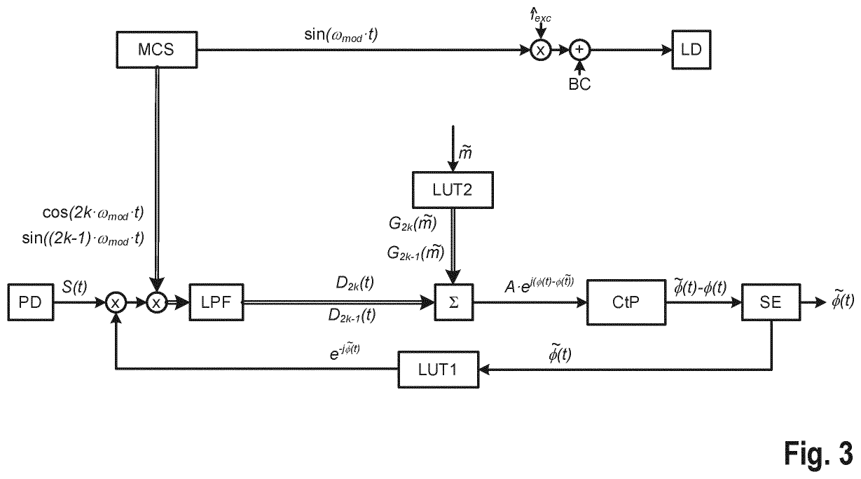

FIG. 3 is a flow diagram illustrating such a method for a single axis at a high level of abstraction. It is proposed to estimate the modulation index m for each axis independently, using the relative amplitudes of N≥2 even-order demodulation carriers and the relative amplitudes of N≥2 odd-order demodulation carriers. Where features of this method are the same as that illustrated by FIG. 2, these features will not necessarily be described again. The estimated modulation index, denoted by m, can then be used to define (e.g., via a first weighting coefficients look-up table LUT2) a set of first weighting coefficients G₁(\tilde{m}), G₂(\tilde{m}), G₃(\tilde{m}), G₄(\tilde{m}) which are expected to equalize the corresponding carrier amplitudes in such a way as to obtain a constant-magnitude first phasor A·e^{j(φ-φ̅)}. By a Cartesian-to-Polar coordinate transformation unit CtP, the phase residual φ̅-φ can be retrieved from this constant-magnitude phasor, free of cyclic error, and can be used to correct the dynamic state predicted by the process model SE.

In an embodiment, a first weighted combination or summation of demodulates may comprise:

$${\sum }_{k = 1}^{N} {G}_{2 k} ( \tilde{m} ) \cdot {D}_{2 k} + j \cdot {G}_{2 k - 1} ( \tilde{m} ) \cdot {D}_{2 k - 1} \approx A \cdot {\sum }_{k = 1}^{N} \begin{matrix}( {G}_{2 k} ( \tilde{m} ) \cdot {J}_{2 k} ( m ) + {G}_{2 k - 1} ( \tilde{m} ) \cdot {J}_{2 k - 1} ( m ) ) \cdot {e}^{j ( ϕ - \hat{ϕ} )} + \\ ( {G}_{2 k} ( \tilde{m} ) \cdot {J}_{2 k} ( m ) - {G}_{2 k - 1} ( \tilde{m} ) \cdot {J}_{2 k - 1} ( m ) ) \cdot 〈 {e}^{- j ( ϕ + \hat{ϕ} )} 〉\end{matrix}$$

wherein each demodulation component or demodulate Dₙ comprises a low pass filtered product of each respective demodulation carrier of interest with the measured interferometer signal S(t) and the unity-magnitude complex conjugate phasor e^{-jφ(t)}, as has already been described. In this embodiment, (at least) four demodulation components or demodulates will now be required, two even and two odd, rather than two demodulates (i.e., N=2). More than four demodulates may be used, but at a cost in implementation complexity.

For this weighted addition to result in the desired complex phasor A·e^{j(φ-φ̅)}, each of the following 3 conditions should be satisfied:

$$\tilde{m} = m$$

$${\sum }_{k = 1}^{N} {G}_{2 k} ( \tilde{m} ) \cdot {J}_{2 k} ( \tilde{m} ) = 1$$

$${\sum }_{k = 1}^{N} {G}_{2 k - 1} ( \tilde{m} ) \cdot {J}_{2 k - 1} ( \tilde{m} ) = 1$$

The first condition states that the modulation index estimate m should be accurate. How this is achieved will be described later. The other two conditions impose single constraints on the set of even-order first weighting coefficients and on the set of odd-order first weighting coefficients. Given that there are N≥2 coefficients in each set, this provides N−1≥1 degrees of freedom for choosing the coefficients within each of both sets. This freedom may be used to minimize the noise amplification by the weighted addition. An example illustrating this will be described for the case where the noise spectral density of the signal S(t) is white. In such a case, the demodulates Dₙ comprise independent additive noises of equal variance. This means that the root-mean-square (rms) noise in the weighted sum can be calculated as the rms noise in any of the demodulates, amplified by the respective factors; e.g.:

$$\sqrt{{\sum }_{k = 1}^{N} {G}_{2 k}^{2} ( \tilde{m} )} ,$$

$$\sqrt{{\sum }_{k = 1}^{N} {G}_{2 k - 1}^{2} ( \tilde{m} )} ,$$

These factors can be recognized as the lengths of the respective vectors:

$${G}_{even} ( \tilde{m} ) = ( \begin{matrix}{G}_{2} ( \tilde{m} ) \\ ⋮ \\ {G}_{2 N} ( \tilde{m} )\end{matrix} ) ,$$

$${G}_{odd} ( \tilde{m} ) = ( \begin{matrix}{G}_{1} ( \tilde{m} ) \\ ⋮ \\ {G}_{2 N - 1} ( \tilde{m} )\end{matrix} ) .$$

Therefore, minimal noise amplification is achieved for the smallest vectors Gₑᵥₑₙ and G_{odd} that satisfy the constraints given above. These constraints in turn can be interpreted as dot-products with the respective vectors of even-order and odd-order Bessel functions:

$${J}_{even} ( \tilde{m} ) = ( \begin{matrix}{J}_{2} ( \tilde{m} ) \\ ⋮ \\ {J}_{2 N} ( \tilde{m} )\end{matrix} ) ,$$

$${J}_{odd} ( \tilde{m} ) = ( \begin{matrix}{J}_{1} ( \tilde{m} ) \\ ⋮ \\ {J}_{2 N - 1} ( \tilde{m} )\end{matrix} )$$

Thus the smallest vectors Gₑᵥₑₙ and G_{odd} are sought which will make a unity dot product with the respective vectors Jₑᵥₑₙ and J_{odd}. In other words, the vectors Gₑᵥₑₙ and G_{odd} should be chosen parallel to the vectors Jₑᵥₑₙ and J_{odd}, and should be normalized to their squared length:

$${G}_{even} ( \tilde{m} ) = \frac{{J}_{even} ( \tilde{m} )}{{‖ {J}_{even} ( \tilde{m} ) ‖}^{2}} ,$$

$${G}_{odd} ( \tilde{m} ) = \frac{{J}_{odd} ( \tilde{m} )}{{‖ {J}_{odd} ( \tilde{m} ) ‖}^{2}} .$$

Therefore noise-optimal coefficients G₂ₖ(\tilde{m}), G₂ₖ₋₁(\tilde{m}) may be found from:

$${G}_{2 k} ( \tilde{m} ) = \frac{{J}_{2 k} ( \tilde{m} )}{{\sum }_{p = 1}^{N} {J}_{2 p}^{2} ( \tilde{m} )} , {G}_{2 k - 1} ( \tilde{m} ) = \frac{{J}_{2 k - 1} ( \tilde{m} )}{{\sum }_{p = 1}^{N} {J}_{2 p - 1}^{2} ( \tilde{m} )} .$$

These weighting coefficients can be pre-calculated for an expected range of the estimated modulation index and stored in lookup tables LUT2 (e.g., in an FPGA comprising the algorithm embodying the proposed method). If the noise in the detected signal S(t) is known to have a particular non-white spectral density, the above calculation of the coefficients can be modified by first applying noise-whitening virtual gains to each of the demodulates, after which the calculation of the G coefficients is conceptually the same. The stored coefficients are then determined as the products of the respective noise-whitening gains and the corresponding G coefficients, calculated after applying the noise whitening gains to the demodulates.

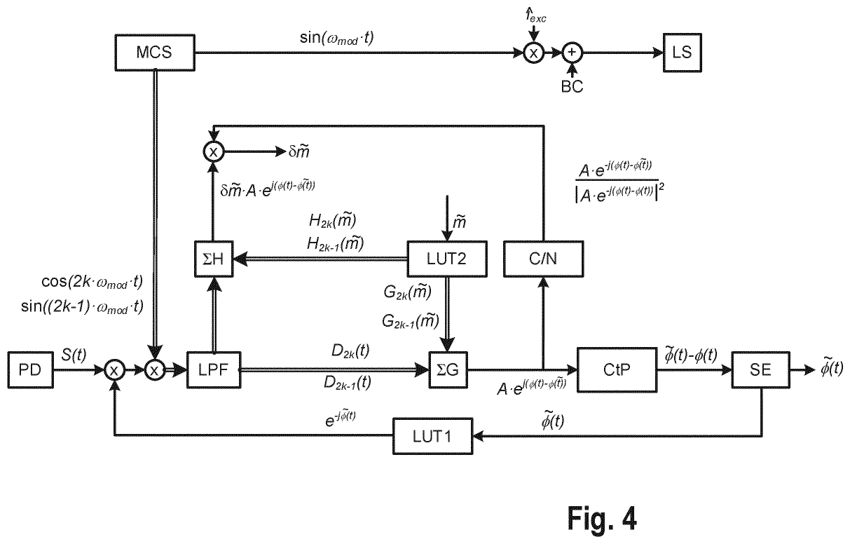

FIG. 4 illustrates the proposed method at a second level of abstraction. Returning to the first condition for accurate phasor construction, i.e., that the modulation estimate should be accurate (\tilde{m}=m), it is proposed that this may be achieved by iteratively updating (refining) the modulation index estimate \tilde{m}. This iterative updating of the modulation index estimate m may be based on a modulation index residual δ\tilde{m} which approximates the true error \tilde{m}−m and which is constructed from a second weighted addition of demodulates Dₙ. This is inspired by the notion that both the ratios of different even-order Bessel functions and the ratios of different odd-order Bessel functions comprise information on the modulation index m. Given a reasonable initial estimate \tilde{m} (e.g., from prior knowledge), a residual δ\tilde{m} is constructable from the known (first-order) derivatives of the Bessel functions at the estimate \tilde{m}. The inventors have determined that the following second weighted combination or weighted summation results in a phasor (second phasor) that is linearly proportional to modulation index residual δ\tilde{m},

$$δ \tilde{m} \cdot A \cdot {e}^{j ( ϕ - \tilde{ϕ} )} = {\sum }_{k = 1}^{N} {H}_{2 k} ( \tilde{m} ) \cdot {D}_{2 k} + j \cdot {H}_{2 k - 1} ( \tilde{m} ) \cdot {D}_{2 k - 1} .$$

By determining the set of second weighting coefficients Hₙ(\tilde{m}) which satisfy this equation, the modulation index residual δ\tilde{m} can be extracted (including its sign) by a multiplication with a squared-magnitude-normalized conjugate of the position-residual phasor A·e^{j(φ-φ̅)}. The construction of the position-residual phasor has already been described:

$$δ \tilde{m} = ( δ \tilde{m} \cdot A \cdot {e}^{j ( ϕ - \tilde{ϕ} )} ) \cdot ( \frac{A \cdot {e}^{- j ( ϕ - \tilde{ϕ} )}}{{\vert A \cdot {e}^{- j ( ϕ - \tilde{ϕ} )} \vert}^{2}} )$$

By substituting the expressions for the demodulates, the H-weighted addition can be rewritten as:

$$δ \tilde{m} \cdot A \cdot {e}^{j ( ϕ - \tilde{ϕ} )} \approx A \cdot \frac{1}{2} {\sum }_{k = 1}^{N} \begin{matrix}( {H}_{2 k} ( \tilde{m} ) \cdot {J}_{2 k} ( m ) + {H}_{2 k - 1} ( \tilde{m} ) \cdot {J}_{2 k - 1} ( m ) ) \cdot {e}^{j ( ϕ - \tilde{ϕ} )} + \\ ( {H}_{2 k} ( \tilde{m} ) \cdot {J}_{2 k} ( m ) - {H}_{2 k - 1} ( \tilde{m} ) \cdot {J}_{2 k - 1} ( m ) ) \cdot 〈 {e}^{- j ( ϕ + \tilde{ϕ} )} 〉\end{matrix}$$

Approximating the true, but inaccessible, modulation index m in terms of the estimate \tilde{m} and the estimation error δ\tilde{m} according to \tilde{m}=m-δ\tilde{m} yields:

$$δ \tilde{m} \cdot A \cdot {e}^{j ( ϕ - \tilde{ϕ} )} \approx A \cdot \frac{1}{2} {\sum }_{k = 1}^{N} \begin{matrix}( {H}_{2 k} ( \tilde{m} ) \cdot {J}_{2 k} ( \tilde{m} - δ \tilde{m} ) + {H}_{2 k - 1} ( \tilde{m} ) \cdot {J}_{2 k - 1} ( \tilde{m} - δ \tilde{m} ) ) \cdot {e}^{j ( ϕ - \tilde{ϕ} )} + \\ ( {H}_{2 k} ( \tilde{m} ) \cdot {J}_{2 k} ( \tilde{m} - δ \tilde{m} ) - {H}_{2 k - 1} ( \tilde{m} ) \cdot {J}_{2 k - 1} ( \tilde{m} - δ \tilde{m} ) ) \cdot 〈 {e}^{- j ( ϕ + \tilde{ϕ} )} 〉\end{matrix}$$

The Bessel functions can then be linearized around \tilde{m} using the first-order derivatives:

$$δ \tilde{m} \cdot A \cdot {e}^{j ( ϕ - \tilde{ϕ} )} \approx A \cdot \frac{1}{2} {\sum }_{k = 1}^{N} \begin{matrix}( {H}_{2 k} ( \tilde{m} ) \cdot ( {J}_{2 k} ( \tilde{m} ) - {J}_{2 k}^{′} ( \tilde{m} ) \cdot δ \tilde{m} ) + {H}_{2 k - 1} ( \tilde{m} ) \cdot ( {J}_{2 k - 1} ( \tilde{m} ) - {J}_{2 k - 1}^{′} ( \tilde{m} ) \cdot δ \tilde{m} ) ) \cdot {e}^{j ( ϕ - \tilde{ϕ} )} + \\ ( {H}_{2 k} ( \tilde{m} ) \cdot ( {J}_{2 k} ( \tilde{m} ) - {J}_{2 k}^{′} ( \tilde{m} ) \cdot δ \tilde{m} ) - {H}_{2 k - 1} ( \tilde{m} ) \cdot ( {J}_{2 k - 1} ( \tilde{m} ) - {J}_{2 k - 1}^{′} ( \tilde{m} ) \cdot δ \tilde{m} ) ) \cdot 〈 {e}^{- j ( ϕ + \tilde{ϕ} )} 〉\end{matrix}$$

where a prime indicates a derivative.

Since this expression has to hold for a range of values of \tilde{m} and δ\tilde{m}, as well as for any value of the phase residual φ-φ̅, it breaks down into the following set of four requirements:

$$0 = {\sum }_{k = 1}^{N} {H}_{2 k} ( \tilde{m} ) \cdot {J}_{2 k} ( \tilde{m} )$$

$$- 1 = {\sum }_{k = 1}^{N} {H}_{2 k} ( \tilde{m} ) \cdot {J}_{2 k}^{′} ( \tilde{m} )$$

$$0 = {\sum }_{k = 1}^{N} {H}_{2 k - 1} ( \tilde{m} ) \cdot {J}_{2 k - 1} ( \tilde{m} )$$

$$- 1 = {\sum }_{k = 1}^{N} {H}_{2 k - 1} ( \tilde{m} ) \cdot {J}_{2 k - 1}^{′} ( \tilde{m} )$$

In a similar manner to the G coefficients, two H vectors may be defined according to:

$${H}_{even} ( \tilde{m} ) = ( \begin{matrix}{H}_{2} ( \tilde{m} ) \\ ⋮ \\ {H}_{2 N} ( \tilde{m} )\end{matrix} ) , {H}_{odd} ( \tilde{m} ) = ( \begin{matrix}{H}_{1} ( \tilde{m} ) \\ ⋮ \\ {H}_{2 N - 1} ( \tilde{m} )\end{matrix} )$$

and the set of four equations can be written as two independent sets of two dot-product equations:

$$\{ \begin{matrix}{H}_{even} ( \tilde{m} ) \cdot {J}_{even} ( \tilde{m} ) = 0 \\ {H}_{even} ( \tilde{m} ) \cdot {J}_{even}^{′} ( \tilde{m} ) = - 1\end{matrix}$$

$$\{ \begin{matrix}{H}_{odd} ( \tilde{m} ) \cdot {J}_{odd} ( \tilde{m} ) = 0 \\ {H}_{odd} ( \tilde{m} ) \cdot {J}_{odd}^{′} ( \tilde{m} ) = - 1\end{matrix}$$

For an embodiment where N=2, the two equations of each set fully define the then two components of the corresponding H vector. The first equation of each set defines the (2D) direction of the corresponding H vector to be perpendicular to the corresponding J vector. The second equation sets the length (and sign) of the H vector. Thus, in the case N=2, the individual coefficients can be calculated according to:

$${H}_{2} ( \tilde{m} ) = \frac{- {J}_{4} ( \tilde{m} )}{{J}_{2}^{′} ( \tilde{m} ) {J}_{4} ( \tilde{m} ) - {J}_{2} ( \tilde{m} ) {J}_{4}^{′} ( \tilde{m} )} , {H}_{4} ( \tilde{m} ) = \frac{{J}_{2} ( \tilde{m} )}{{J}_{2}^{′} ( \tilde{m} ) {J}_{4} ( \tilde{m} ) - {J}_{2} ( \tilde{m} ) {J}_{4}^{′} ( \tilde{m} )}$$

$${H}_{1} ( \tilde{m} ) = \frac{- {J}_{3} ( \tilde{m} )}{{J}_{1}^{′} ( \tilde{m} ) {J}_{3} ( \tilde{m} ) - {J}_{1} ( \tilde{m} ) {J}_{3}^{′} ( \tilde{m} )} , {H}_{3} ( \tilde{m} ) = \frac{{J}_{1} ( \tilde{m} )}{{J}_{1}^{′} ( \tilde{m} ) {J}_{3} ( \tilde{m} ) - {J}_{1} ( \tilde{m} ) {J}_{3}^{′} ( \tilde{m} )}$$

The Bessel function derivatives can be expressed in terms of higher or lower-order Bessel functions using the recurrence relations:

$$\begin{matrix}{J}_{k}^{′} ( m ) = {J}_{k - 1} ( m ) - \frac{k}{m} \cdot {J}_{k} ( m ) \\ = \frac{k}{m} \cdot {J}_{k} ( m ) - {J}_{k + 1} ( m )\end{matrix} ,$$

which gives the final expressions:

$${H}_{2} ( \tilde{m} ) = \frac{- {J}_{4} ( \tilde{m} )}{\frac{6}{\tilde{m}} {J}_{2} ( \tilde{m} ) {J}_{4} ( \tilde{m} ) - ( {J}_{4} ( \tilde{m} ) + {J}_{2} ( \tilde{m} ) ) \cdot {J}_{3} ( \tilde{m} )} , \\ {H}_{4} ( \tilde{m} ) = \frac{{J}_{2} ( \tilde{m} )}{\frac{6}{\tilde{m}} {J}_{2} ( \tilde{m} ) {J}_{4} ( \tilde{m} ) - ( {J}_{4} ( \tilde{m} ) + {J}_{2} ( \tilde{m} ) ) \cdot {J}_{3} ( \tilde{m} )}$$

$${H}_{1} ( \tilde{m} ) = \frac{- {J}_{3} ( \tilde{m} )}{\frac{4}{\tilde{m}} \cdot {J}_{1} ( \tilde{m} ) {J}_{3} ( \tilde{m} ) - ( {J}_{3} ( \tilde{m} ) + {J}_{1} ( \tilde{m} ) ) \cdot {J}_{2} ( \tilde{m} )} , \\ {H}_{3} ( \tilde{m} ) = \frac{{J}_{1} ( \tilde{m} )}{\frac{4}{\tilde{m}} \cdot {J}_{1} ( \tilde{m} ) {J}_{3} ( \tilde{m} ) - ( {J}_{3} ( \tilde{m} ) + {J}_{1} ( \tilde{m} ) ) \cdot {J}_{2} ( \tilde{m} )}$$

These H coefficients can be pre-calculated for an expected range of m and stored in lookup tables (e.g., in a second weighting coefficients look-up table e.g., as implemented in an FPGA comprising the algorithm embodying the proposed method). This second weighting coefficients look-up table may be the same table as the first weighting coefficients look-up table, e.g., LUT2, or otherwise) The foregoing proves that indeed H-coefficients can be calculated that satisfy all constraints. Hence a modulation index residual δ\tilde{m} can be constructed over a range of modulation indices. It can be appreciated, however, that there may be some limits on this range. For both low and high modulation indices, one or more of the H coefficients (and even the G coefficients) may increase so much that it results in extreme noise amplification; these regimes should be avoided. By taking higher-order PGCs into account (i.e., N>2) the useable range can be extended on the high-modulation index side. The penalties however are higher FPGA resource usage and higher requirement on analog bandwidth and sampling rate. With N>2, the H vectors comprise more components, which gives freedom for noise optimization, just as has been demonstrated for the G coefficients.

A scaled-down version of this signed modulation index residual δm can then be used to update the modulation index estimate. This updating improves the accuracy of the modulation index estimate \tilde{m} and ensures that the modulation index estimate \tilde{m} will track changes over time in the actual modulation index m, resulting from a time varying OPD. This can be done separately for different interferometers (e.g., different axes of a multi-axis interrogator), such that the respective modulation indices of multiple measurement axes can be tracked simultaneously and independently. This allows these axes to perform simultaneous measurements, free of cyclic errors, using a single laser diode.

This proposed modulation index tracking does not actually require a reasonable estimate of the measurand-induced phase. Therefore modulation index tracking can commence prior to ‘locking’ the main measurement. This greatly simplifies the initialization procedure needed to get the interrogator running accurately.

The modulation index is proportional to the measurand-induced phase φ, with the proportionality factor being the (quasi-static) ratio r_{λ} of the wavelength excursion amplitude Δλ to the central wavelength λ (i.e., r_{λ}=Δλ/λ) of the laser radiation:

$$m = {r}_{λ} \cdot ϕ$$

Thus, the modulation index estimator could be implemented as a second dynamic state estimator (not shown in the Figures), similar to the dynamic state estimator SE of the process model, in order to be able to accurately track measurand-induced OPD changes of high velocity/acceleration/jerk. This means that the method utilizes two dynamic state estimators, both tracking essentially the same (although differently scaled) OPD changes and both having similar bandwidth. Such an approach is within the scope of this disclosure, and as such the method may comprise using a (second) dynamic state estimator to determine a modulation index estimate m for determining the G and H coefficients.

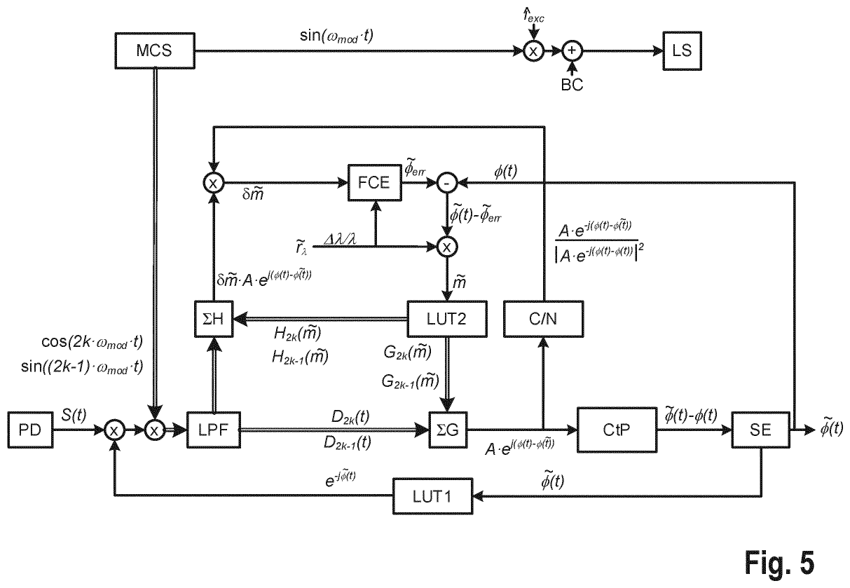

FIG. 5 shows the proposed alternative method at a lower level of abstraction, where the modulation index estimate \tilde{m} is predicted from the measurand-induced phase estimate φ̅ (e.g., indicative of the instant position of a component being tracked where the interrogator is part of a position measurement system) output from the dynamic state estimator SE or process model. This is more efficient than providing a second dynamic state estimator, as it requires far less duplication of effort.

This embodiment comprises defining two other estimated variables, one of the aforementioned ratio r_{λ}, denoted as \tilde{r}_{λ}, and another being the estimate of the static ‘fringe count error’ (FCE) φ̅ₑᵣᵣ in the estimated measurand induced phase φ̅, both of which are essentially quasi-static variables. Estimating these quasi-static variables, rather than the rapidly varying modulation index, can be achieved with much lower bandwidth and hence better noise averaging. The relation between modulation index prediction m and measurand-induced phase estimate φ̅ may be defined as:

$$\tilde{m} = {\tilde{r}}_{λ} \cdot ( \tilde{ϕ} - {\tilde{ϕ}}_{err} )$$

The wavelength ratio estimate r_{λ}, is by definition the same for all axes of a multi-axis system. It can be preset, calibrated or continuously estimated. The fringe count error estimate φ̅ₑᵣᵣ of each axis can be corrected by the modulation index residual δ\tilde{m}ₗ, according to the 1st-order update equation:

$${\tilde{ϕ}}_{err , l} = {\tilde{ϕ}}_{err , l - 1} + α \cdot {\tilde{r}}_{λ}^{- 1} \cdot δ {\tilde{m}}_{l}$$

where the coefficient 0<α<1 is a bandwidth parameter and l is a sampling instant index.

The proposed signal processing method (e.g., an algorithm embodying the method and associated look-up tables) may be implemented in software or in firmware (e.g., in a programmable firmware component such as a Field Programmable Gate Array FPGA).

Also disclosed is a phase generated carrier interferometer interrogator comprising at least one interferometer, being operable to perform any of the methods disclosed herein to process (e.g., demodulate) the detected interferometer signal. The phase generated carrier interferometer interrogator may comprise, for example, a multi-interferometer or multi-axis phase generated carrier interferometer interrogator which uses a common laser (e.g., laser diode) for each interferometer/axis.

Also disclosed is a position measurement system for measuring the position of a component of a machine, such as a lithographic apparatus (e.g., a scanner) comprising at least one interferometer, and being operable to perform any of the methods disclosed herein to process (e.g., demodulate) the detected interferometer signal. The position measurement system may comprise a (e.g., multi-axis) phase generated carrier interferometer interrogator as described. The component may comprise, for example, a stage (e.g., wafer stage or reticle stage) of the lithographic apparatus, or any other component such as a projection component (e.g., steering or beam delivery mirror) of a projection system of a lithographic apparatus (e.g., an EUV lithographic apparatus). The position measurement system may be operable to measure any two or more axes, each of the two or more axes relating to a respective degree of freedom of the component being measured. In a specific example, position measurement system may be operable to measure six axes, the three spatial axes x, y, z and rotations Rx, Ry, Rz around each of these axes.

Also disclosed is a lithographic apparatus comprising at least one such position measurement system for measuring a position of a component of the lithographic apparatus.

Although specific reference may be made in this text to the use of a lithographic apparatus in the manufacture of ICs, it should be understood that the lithographic apparatus described herein may have other applications. Possible other applications include the manufacture of integrated optical systems, guidance and detection patterns for magnetic domain memories, flat-panel displays, liquid-crystal displays (LCDs), thin-film magnetic heads, etc.

Although specific reference may be made in this text to embodiments of the invention in the context of a lithographic apparatus, embodiments of the invention may be used in other apparatus. Embodiments of the invention may form part of a mask inspection apparatus, a metrology apparatus, or any apparatus that measures or processes an object such as a wafer (or other substrate) or mask (or other patterning device). These apparatus may be generally referred to as lithographic tools. Such a lithographic tool may use vacuum conditions or ambient (non-vacuum) conditions.

Although specific reference may have been made above to the use of embodiments of the invention in the context of optical lithography, it will be appreciated that the invention, where the context allows, is not limited to optical lithography and may be used in other applications, for example imprint lithography.

Where the context allows, embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic storage media; optical storage media; flash memory devices; electrical, optical, acoustical or other forms of propagated signals (e.g. carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. and in doing that may cause actuators or other devices to interact with the physical world.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below. Other aspects of the invention are set-out as in the following numbered clauses.
1. A phase generated carrier interrogator, comprising:
   one or more interferometers, each said one or more interferometers being operable to receive modulated radiation and to generate a respective interferometer signal comprising a phase of interest induced by a measurand, each said interferometer signal also comprising a periodic phase modulation induced by said modulated radiation, wherein the periodic phase modulation comprises an amplitude described by a respective modulation index for each said one or more interferometers; at least one detector operable to detect each said interferometer signal; and a signal processing module operable to:
   estimate the modulation index respectively for each said one or more interferometers to obtain a respective estimated modulation index for each said one or more interferometers; and
demodulate each of said interferometer signals using its respective estimated modulation index to estimate a respective phase of interest from each of said interferometer signals thereby obtaining a respective estimated phase of interest value for each said interferometer.
2. A phase generated carrier interrogator according to clause 1, wherein said signal processing module is operable, for each of said one or more interferometers, to determine a respective demodulate component for each of at least four demodulation carrier frequencies, said at least four demodulation carrier frequencies comprising at least two even-order demodulation carrier frequencies and at least two odd-order demodulation carrier frequencies, said demodulation carrier frequencies comprising harmonics of a modulation frequency of said periodic phase modulation.
3. A phase generated carrier interrogator according to clause 2, wherein said signal processing module is operable to determine, for each of said one or more interferometers, each demodulate component as a combination of: each respective demodulation carrier frequency, the interferometer signal and a unity-magnitude complex conjugate phasor having an argument which is the negative estimated phase of interest value.
4. A phase generated carrier interrogator according to clause 3, wherein said signal processing module is operable to determine said unity-magnitude complex conjugate phasor from said estimated phase of interest value.
5. A phase generated carrier interrogator according to any of clauses 2 to 4, wherein said signal processing module is operable, for each of said one or more interferometers, to use the respective estimated modulation index for that interferometer to define a set of first weighting coefficients for said demodulate components, said first weighting coefficients being defined such that a first weighted combination of said demodulate components, as weighted by said first weighting coefficients, yields a first phasor having an argument comprising a phase residual describing an error in the estimated phase of interest value.
6. A phase generated carrier interrogator according to clause 5, wherein said signal processing module is further operable to determine said phase residual from said first phasor.
7. A phase generated carrier interrogator according to clause 6, wherein said signal processing module further comprises a dynamic state estimator operable to determine a new state comprising said estimated phase of interest value from a previous state and from said phase residual.
8. A phase generated carrier interrogator according to clause 5, 6 or 7, wherein said signal processing module comprises a first weighting coefficients look-up table and said set of first weighting coefficients are chosen based on each respective estimated modulation index in accordance with the first weighting coefficients look-up table.
9. A phase generated carrier interrogator according to any of clauses 5 to 8, wherein said set of first weighting coefficients comprise a respective vector of even-order first weighting coefficients for weighting each of said at least two even-order demodulate components and a respective vector of odd-order first weighting coefficients for weighting each of said at least two odd-order demodulate components, and
   wherein said signal processing module is operable, for each of said one or more interferometers, to: determine each said vector of even-order first weighting coefficients as being parallel to a respective normalized vector of even-order Bessel functions of the same order and corresponding to the estimated modulation index; and
   determine each said vector of odd-order first weighting coefficients as being parallel to a respective normalized vector of odd-order Bessel functions of the same order and corresponding to the estimated modulation index.
10. A phase generated carrier interrogator according to any of clauses 5 to 9, wherein said signal processing module is operable to estimate each modulation index from relative amplitudes of said two even-order demodulate components and at least two odd-order carriers demodulate components.
11. A phase generated carrier interrogator according to any of clauses 5 to 10, wherein said signal processing module is operable to estimate the modulation index respectively for each said one or more interferometers by iteratively updating a modulation index estimate based on a modulation index residual.
12. A phase generated carrier interrogator according to clause 11, wherein said signal processing module is operable to estimate said modulation index residual based on a second weighted combination of said demodulate components as weighted by a set of second weighting coefficients to yield a second phasor which is linearly proportional to the modulation index residual.
13. A phase generated carrier interrogator according to clause 12, wherein said signal processing module is operable to extract said modulation index residual by combining said second phasor with a normalized conjugate of said first phasor.
14. A phase generated carrier interrogator according to clause 12 or 13, wherein said set of second weighting coefficients comprise a respective vector of even-order second weighting coefficients for weighting each of said at least two even-order demodulate components and a respective vector of odd-order second weighting coefficients for weighting each of said at least two odd-order demodulate components; and wherein said set of second weighting coefficients are defined such that:
   the sum of dot products of each said vector of even-order second weighting coefficients with a corresponding vector of even-order Bessel functions of the estimated modulation index is zero;
   the sum of dot products of each said vector of odd-order second weighting coefficients with a corresponding vector of odd-order Bessel functions of the estimated modulation index is zero;
   the sum of dot products of each said vector of even-order second weighting coefficients with a derivative of a corresponding vector of even-order Bessel functions of the estimated modulation index is −1; and
   the sum of dot products of each said vector of odd-order second weighting coefficients with a derivative of a corresponding vector of odd-order Bessel functions of the estimated modulation index is −1.
15. A phase generated carrier interrogator according to clause 12, 13 or 14, wherein said signal processing module comprises a second weighting coefficients look-up table and said set of second weighting coefficients are chosen based on each respective estimated modulation index in accordance with the second weighting coefficients look-up table.
16. A phase generated carrier interrogator according to any of clauses 11 to 15, wherein said signal processing module is operable to determine said estimated modulation index from an updated fringe count error estimate in said estimated phase of interest value, said updated fringe count error estimate having been updated by said modulation index residual.
17. A phase generated carrier interrogator according to clause 16, wherein said signal processing module is operable to determine said estimated modulation index from said updated fringe count error estimate and an estimated ratio of a wavelength excursion amplitude to the central wavelength of the modulated radiation.
18. A phase generated carrier interrogator according to any preceding clause, comprising a programmable firmware component programmed to implement said signal processing module
19. A phase generated carrier interrogator according to any preceding clause, further comprising a plurality of said interferometers.
20. A phase generated carrier interrogator according to clause 19, further comprising a common radiation source for generating radiation to be modulated to obtain said modulated radiation for each of said plurality of said interferometers.
21. A multi-axis position measuring system comprising the phase generated carrier interrogator according to clause 19 or 20, wherein each of said plurality of interferometers is used to measure a respective axis of said multi-axis position measuring system.
22. A multi-axis position measuring system according to clause 21, wherein said multi-axis position measuring system comprises at least three axes for measuring three rigid-body position coordinates related to the measurand.
23. A multi-axis position measuring system according to clause 21, wherein said multi-axis position measuring system comprises at least six axes for measuring three rigid-body position coordinates and three rigid-body attitude coordinates related to the measurand.
24. A lithographic apparatus comprising the multi-axis position measuring system according to any of clauses 21 to 23, wherein said multi-axis position measuring system is operable to measure the position of a component of said lithographic apparatus.
25. A projection system for an optical lithography system comprising the multi-axis position measuring system according to any of clauses 21 to 23, wherein said multi-axis position measuring system is operable to measure the position of a component of said projection system.
26. A method of processing one or more interferometer signals to determine an estimated phase of interest value induced by a measurand, each of the one or more interferometer signals being obtained from a respective interferometer of one or more interferometers; the method comprising: modulating radiation for each said one or more interferometers to apply a periodic phase modulation having an amplitude described by a respective modulation index for each interferometer; detecting a respective interferometer signal for each said one or more interferometers, each interferometer signal comprising a phase of interest induced by the measurand in addition to said periodic phase modulation;
   estimating the modulation index respectively for each said one or more interferometers to obtain a respective estimated modulation index for each said one or more interferometers; and demodulating each of said interferometer signals using its respective estimated modulation index to estimate a respective phase of interest from each of said interferometer signals thereby obtaining a respective estimated phase of interest value for each said interferometer.
27. A method according to clause 26, comprising, for each of said one or more interferometers: determining a respective demodulate component for each of at least four demodulation carrier frequencies, said at least four demodulation carrier frequencies comprising at least two even-order demodulation carrier frequencies and at least two odd-order carriers demodulation carrier frequencies, said demodulation carrier frequencies comprising harmonics of a modulation frequency of said periodic phase modulation.
28. A method according to clause 27, comprising, for each of said one or more interferometers: determining each demodulate component as a combination of: each respective demodulation carrier frequency, the interferometer signal and a unity-magnitude complex conjugate phasor having an argument which is the negative estimated phase of interest value.
29. A method according to clause 28, comprising determining said unity-magnitude complex conjugate phasor from said estimated phase of interest value.
30. A method according to any of clauses 27 to 29, comprising, for each of said one or more interferometers:
   using the respective estimated modulation index for that interferometer to define a set of first weighting coefficients for said demodulate components, said first weighting coefficients being defined such that a first weighted combination of said demodulate components, as weighted by said first weighting coefficients, yields a first phasor having an argument comprising a phase residual describing an error in the estimated phase of interest value.
31. A method according to clause 28, wherein said signal processing module is further operable to determine said phase residual from said first phasor; and determining said estimated phase of interest value from said phase residual.
32. A method according to clause 30 or 31, comprising selecting said set of first weighting coefficients based on each respective estimated modulation index in accordance with a first weighting coefficients look-up table.
33. A method according to any of clauses 30 to 32, wherein said set of first weighting coefficients comprise respective even-order first weighting coefficients for weighting each of said at least two even-order demodulate components and respective odd-order first weighting coefficients for weighting each of said at least two odd-order demodulate components, and the method further comprises, for each of said one or more interferometers:
   determining a vector of each said even-order first weighting coefficients as being parallel to a respective normalized vector of even-order Bessel functions of the same order and corresponding to the estimated modulation index; and
   determining a vector of each said odd-order first weighting coefficients as being parallel to a respective normalized vector of odd-order Bessel function of the same order and corresponding to the estimated modulation index.
34. A method according to any of clauses 30 to 33, comprising estimating each modulation index from relative amplitudes of said two even-order demodulate components and at least two odd-order carriers demodulate components.
35. A method according to any of clauses 30 to 34, comprising estimating the modulation index respectively for each said one or more interferometers by iteratively updating a modulation index estimate based on a modulation index residual.
36. A method according to clause 35, comprising estimating said modulation index residual based on a second weighted combination of said demodulate components as weighted by a set of second weighting coefficients to yield a second phasor which is linearly proportional to the modulation index residual.
37. A method according to clause 36, comprising extracting said modulation index residual by combining said second phasor with a normalized conjugate of said first phasor.
38. A method according to clause 36 or 37, wherein said set of second weighting coefficients comprise respective even-order second weighting coefficients for weighting each of said at least two even-order demodulate components and respective odd-order second weighting coefficients for weighting each of said at least two odd-order demodulate components; and wherein said set of second weighting coefficients are defined such that:
   the dot product of the vector of all said even-order second weighting coefficients with the vector of the corresponding even-order Bessel functions is zero;
   the dot product of the vector of all said odd-order second weighting coefficients with the vector of the corresponding odd-order Bessel functions is zero;
   the dot product of the vector of all said even-order second weighting coefficients with a derivative of the vector of the corresponding even-order Bessel functions is −1; and
   the dot product of the vector of all said odd-order second weighting coefficients with a derivative of the vector of the corresponding odd-order Bessel functions is −1.
39. A method according to clause 36, 37 or 38, comprising selecting said set of second weighting coefficients based on each respective estimated modulation index in accordance with a second weighting coefficients look-up table.
40. A method according to any of clauses 35 to 39, comprising determining said estimated modulation index from an updated fringe count error estimate in said estimated phase of interest value, said updated fringe count error estimate having been updated by said modulation index residual.
41. A method according to clause 40, comprising determining said estimated modulation index from said updated fringe count error estimate and an estimated ratio of a wavelength excursion amplitude to the central wavelength of the modulated radiation.
42. A method according to any of clauses 26 to 41, wherein the method comprises processing a respective interferometer signal from each of a plurality of said interferometers, the plurality of said interferometers using a common radiation source.
43. A method according to any of clauses 26 to 42, comprising determining a respective position value describing a position coordinate of a component of a machine for each estimated phase of interest value.
44. A method according to clause 43, wherein said machine comprises a lithographic apparatus.
45. A computer program comprising computer readable instructions operable to perform the method according to any of clauses 26 to 44.
46. A programmable firmware component programmed to implement the method according to any of clauses 26 to 44.

1-15. (canceled)

16. A phase generated carrier interrogator, comprising:
one or more interferometers, each of the one or more interferometers being operable to receive modulated radiation and to generate a respective interferometer signal comprising a phase of interest induced by a measurand, each of the interferometer signals also comprising a periodic phase modulation induced by the modulated radiation, wherein the periodic phase modulation comprises an amplitude described by a respective modulation index for each of the one or more interferometers;
at least one detector operable to detect each of the interferometer signals; and
a signal processing module operable to:
estimate the modulation index respectively for each of the one or more interferometers to obtain a respective estimated modulation index for each of the one or more interferometers; and
demodulate each of the interferometer signals using its respective estimated modulation index to estimate a respective phase of interest from each of the interferometer signals thereby obtaining a respective estimated phase of interest value for each of the interferometers.

17. The phase generated carrier interrogator of claim 16, wherein:
the signal processing module is operable, for each of the one or more interferometers, to determine a respective demodulate component for each of at least four demodulation carrier frequencies, the at least four demodulation carrier frequencies comprising at least two even-order demodulation carrier frequencies and at least two odd-order demodulation carrier frequencies, the demodulation carrier frequencies comprising harmonics of a modulation frequency of the periodic phase modulation.

18. The phase generated carrier interrogator of claim 17, wherein the signal processing module is operable to determine, for each of the one or more interferometers, each demodulate component as a combination of: each respective demodulation carrier frequency, the interferometer signal and a unity-magnitude complex conjugate phasor having an argument which is the negative estimated phase of interest value.

19. The phase generated carrier interrogator of claim 18, wherein:
the signal processing module is operable to determine the unity-magnitude complex conjugate phasor from the estimated phase of interest value, and/or
the signal processing module is operable, for each of the one or more interferometers, to use the respective estimated modulation index for that interferometer to define a set of first weighting coefficients for the demodulate components, the first weighting coefficients being defined such that a first weighted combination of the demodulate components, as weighted by the first weighting coefficients, yields a first phasor having an argument comprising a phase residual describing an error in the estimated phase of interest value.

20. The phase generated carrier interrogator of claim 19, wherein:
the signal processing module is further operable to determine the phase residual from the first phasor, and/or
the signal processing module comprises a first weighting coefficients look-up table and the set of first weighting coefficients are chosen based on each respective estimated modulation index in accordance with the first weighting coefficients look-up table, and/or
the signal processing module is operable to estimate each modulation index from relative amplitudes of the two even-order demodulate components and at least two odd-order carriers demodulate components, and/or
the signal processing module is operable to estimate the modulation index respectively for each of the one or more interferometers by iteratively updating a modulation index estimate based on a modulation index residual, and/or
the signal processing module is operable to estimate the modulation index residual based on a second weighted combination of the demodulate components as weighted by a set of second weighting coefficients to yield a second phasor which is linearly proportional to the modulation index residual.

21. The phase generated carrier interrogator of claim 20, wherein:
the signal processing module further comprises a dynamic state estimator operable to determine a new state comprising the estimated phase of interest value from a previous state and from the phase residual, and/or
the signal processing module is operable to extract the modulation index residual by combining the second phasor with a normalized conjugate of the first phasor, and/or
the signal processing module is operable to determine the estimated modulation index from an updated fringe count error estimate in the estimated phase of interest value, the updated fringe count error estimate having been updated by the modulation index residual.

22. The phase generated carrier interrogator of claim 19, wherein:
the set of first weighting coefficients comprise a respective vector of even-order first weighting coefficients for weighting each of the at least two even-order demodulate components and a respective vector of odd-order first weighting coefficients for weighting each of the at least two odd-order demodulate components, and
the signal processing module is operable, for each of the one or more interferometers, to:
determine each of the vector of even-order first weighting coefficients as being parallel to a respective normalized vector of even-order Bessel functions of the same order and corresponding to the estimated modulation index; and
determine each of the vector of odd-order first weighting coefficients as being parallel to a respective normalized vector of odd-order Bessel functions of the same order and corresponding to the estimated modulation index, and/or
the set of second weighting coefficients comprise a respective vector of even-order second weighting coefficients for weighting each of the at least two even-order demodulate components and a respective vector of odd-order second weighting coefficients for weighting each of the at least two odd-order demodulate components; and
the set of second weighting coefficients are defined such that:
the sum of dot products of each of the vector of even-order second weighting coefficients with a corresponding vector of even-order Bessel functions of the estimated modulation index is zero;
the sum of dot products of each of the vector of odd-order second weighting coefficients with a corresponding vector of odd-order Bessel functions of the estimated modulation index is zero;
the sum of dot products of each of the vector of even-order second weighting coefficients with a derivative of a corresponding vector of even-order Bessel functions of the estimated modulation index is −1; and
the sum of dot products of each of the vector of odd-order second weighting coefficients with a derivative of a corresponding vector of odd-order Bessel functions of the estimated modulation index is −1.

23. The phase generated carrier interrogator of claim 20, wherein:
the signal processing module comprises a second weighting coefficients look-up table and the set of second weighting coefficients are chosen based on each respective estimated modulation index in accordance with the second weighting coefficients look-up table, and/or
the signal processing module is operable to determine the estimated modulation index from the updated fringe count error estimate and an estimated ratio of a wavelength excursion amplitude to the central wavelength of the modulated radiation.

24. The phase generated carrier interrogator of claim 16, further comprising a programmable firmware component programmed to implement the signal processing module, and/or further comprising a plurality of the interferometers, desirably further comprising a common radiation source for generating radiation to be modulated to obtain the modulated radiation for each of the plurality of the interferometers.

25. A multi-axis position measuring system comprising:
the phase generated carrier interrogator of claim 24,
wherein each of the plurality of interferometers is used to measure a respective axis of the multi-axis position measuring system.

26. A lithographic apparatus comprising:
the multi-axis position measuring system of claim 25,
wherein the multi-axis position measuring system is operable to measure the position of a component of the lithographic apparatus.

27. A projection system for an optical lithography system comprising:
the multi-axis position measuring system of claim 26,
wherein the multi-axis position measuring system is operable to measure the position of a component of the projection system.

28. A method of processing one or more interferometer signals to determine an estimated phase of interest value induced by a measurand, each of the one or more interferometer signals being obtained from a respective interferometer of one or more interferometers, the method comprising:
modulating radiation for each of the one or more interferometers to apply a periodic phase modulation having an amplitude described by a respective modulation index for each interferometer;
detecting a respective interferometer signal for each of the one or more interferometers, each interferometer signal comprising a phase of interest induced by the measurand in addition to the periodic phase modulation;
estimating the modulation index respectively for each of the one or more interferometers to obtain a respective estimated modulation index for each of the one or more interferometers; and
demodulating each of the interferometer signals using its respective estimated modulation index to estimate a respective phase of interest from each of the interferometer signals thereby obtaining a respective estimated phase of interest value for each of the interferometers.

29. A computer program comprising:
computer readable instructions operable to perform the method of claim 28.

30. A programmable firmware component programmed to implement the method of claim 28.
